(19) United States
(12) Patent Application Publication
(10) Pub. No.: US 2026/0169205 A1
(43) Pub. Date: Jun. 18, 2026

(54) OPTICAL GRATINGS HAVING NON-ALIGNED META-OPTICAL ELEMENTS

(71) Applicant: NIL Technology ApS, Kongens Lyngby (DK)

(72) Inventors: Ugur Meric Gur, Kongens Lyngby (DK); Ulrich Quaade, Copenhagen (DK)

(21) Appl. No.: 19/124,437

(22) PCT Filed: Oct. 27, 2023
(86) PCT No.: PCT/EP2023/080163

§ 371 Date: Apr. 25, 2025

Related U.S. Application Data
(60) Provisional application No. 63/420,981, filed on Oct. 31, 2022.

(51) Int. Cl. G02B 5/18

(52) U.S. Cl. CPC G02B 5/1861; G02B 5/1809; G02B 5/1819

(57) ABSTRACT

An example apparatus includes an optical grating having a first axis oriented in a first direction and a second axis oriented in a second direction different from the first direction, wherein a dimension of the optical grating along the first axis is greater than a dimension of the optical grating along the second axis. The optical grating includes cells arranged along the first direction, each of the cells including meta-atoms arranged along the first direction, wherein the meta-atoms in each particular one of the cells are not aligned with respect to the second direction and are arranged in an asymmetric manner about the first axis of the optical grating.

### FIELD OF THE DISCLOSURE

The present disclosure relates to optical gratings.

### BACKGROUND

A diffraction grating is an optical element that disperses light composed of multiple wavelengths into light components according to wavelength. Metasurface-based optical elements can provide ultra-compact beam control elements that can be integrated into a variety of optical systems due to their ultrathin and flat nature and, in some cases, can be easier to fabricate than traditional saw-tooth or blazed gratings. The functionality of such metasurfaces sometimes has been demonstrated with plane waves at normal incidence to the grating. Diffraction efficiency, however, tends to decrease significantly upon illumination with off-normal incidence angles. Further, various factors make it challenging to design metasurfaces that efficiently steer light to large deflection angles, for example, at visible wavelengths. Nevertheless, a large range of acceptance angles, and more uniform efficiency across the angular range, would be desirable for optical elements in some applications.

### SUMMARY

The present disclosure describes optical gratings that include meta-optical elements (MOEs).

In one aspect, the present disclosure describes an apparatus including an optical grating having a first axis oriented in a first direction and a second axis oriented in a second direction different from the first direction, wherein a dimension of the optical grating along the first axis is greater than a dimension of the optical grating along the second axis. The optical grating includes cells arranged along the first direction, each of the cells including meta-atoms arranged along the first direction, wherein the meta-atoms in each particular one of the cells are not aligned with respect to the second direction and are arranged in an asymmetric manner about the first axis of the optical grating.

Some implementations include one or more of the following features. For example, in some implementations, each of the cells has the same arrangement of meta-atoms as other cells of the optical grating. In some cases, the arrangement of the meta-atoms in at least one of the cells is rotated 180°, with respect to the arrangement of the meta-atoms in another one of the cells, about a central axis of the grating. In some cases, the arrangement of the meta-atoms in at least one of the cells is shifted along the second direction relative to the arrangement of the meta-atoms in another one of the cells.

In some implementations, the meta-atoms in each particular one of the cells has a respective size, shape or orientation that differs, respectively, from the size, shape or orientation of other ones of the meta-atoms in the same cell. In some cases, respective positions of two meta-atoms in at least one of the cells overlap partially in the first direction.

In some instances, the optical grating is a one-dimensional grating, whereas in other instances, the optical grating is a two-dimensional grating (e.g., the meta-atoms in each particular cell of the optical grating are in a two-dimensional arrangement).

In some implementations, each of the cells has a dimension shorter than an operational wavelength for the optical grating. In some implementations, at least one of shape, size or location of the meta-atoms differs among the cells of the grating. In some instances, the optical grating is part of a metalens.

The present disclosure also describes an apparatus that includes an optical grating, a light source operable to emit light, an optical detector operable to detect light, and at least one reflective or transmissive surface to direct light emitted by the light source to the optical grating or to direct light from the optical grating to the optical detector.

Some implementations include one or more of the following advantages. For example, the non-alignment can provide an extra degree of freedom in the design of the grating. In some implementations, the arrangement of the meta-atoms can result in a reduced phase transition region (PTR) and can provide a design whose phase distribution that is closer to an ideal saw-tooth type distribution. In some implementations, the optical grating exhibits relatively high diffraction efficiencies over a broad range of angles of incidence. Accordingly, grating performance can be improved in some cases.

Other aspects, features and advantages will be readily apparent from the following detailed description, the accompanying drawings, and the claims.

### BRIEF DESCRIPTION OF THE DRAWINGS

FIG. 1 illustrates an example of an optical grating that includes multiple cells.

FIG. 2 illustrates an ideal saw-tooth type phase distribution.

FIG. 3 illustrates another example of an optical grating that includes aligned meta-atoms.

FIG. 4 illustrates an example of an optical grating that includes non-aligned meta-atoms.

FIG. 5 illustrates a further example of an optical grating that includes non-aligned meta-atoms.

FIG. 6 illustrates yet another example of an optical grating that includes non-aligned meta-atoms.

FIG. 7 illustrates another example of an optical grating that includes non-aligned meta-atoms.

FIG. 8 illustrates yet another example of an optical grating that includes non-aligned meta-atoms.

FIG. 9A is an example of a one-dimensional grating that includes non-aligned meta-atoms; FIG. 9B is an example of a 2D grating that includes non-aligned meta-atoms.

FIG. 10 illustrates an example of an optical system incorporating an optical grating.

FIG. 11 shows an example of a metalens that includes an optical grating that includes calls having non-aligned meta-atoms.

FIG. 12 illustrates an example of an optical transmitter system.

FIG. 13 illustrates an example of an optical receiver system.

### DETAILED DESCRIPTION

The present disclosure describes optical gratings that include meta-optical elements (MOEs). MOEs are advanced optical elements that include a metasurface, which refers to a surface with distributed small structures (e.g., meta-atoms) arranged to interact with light in a particular manner. A metasurface, which also may be referred to as a metastructure, can be a surface with a distributed array of nanostructures. In some cases, the meta-atoms are pillar-or cylinder-shaped, although other shapes can be used in some cases (e.g., meta-atoms having a square cross-section). The meta-atoms may, individually or collectively, interact with light waves. For example, the meta-atoms may change a local amplitude, a local phase, or both, of an incoming light wave. The meta-atoms may be arranged so that the metastructure functions, for example, as an optical grating.

As explained in greater detail below, the meta-atoms that form the optical grating can be distributed along a first direction such that the meta-atoms are not aligned with respect to a second direction different from the first direction. The second direction can orthogonal (i.e., perpendicular) or non-orthogonal to the first direction. Further, the meta-atoms can be arranged such that the non-alignment is asymmetrical. Such an arrangement of the meta-atoms can provide, in some implementations, an optical grating that exhibits high diffraction efficiencies over a relatively broad range of angles of incidence and/or over relatively large angles of incidence.

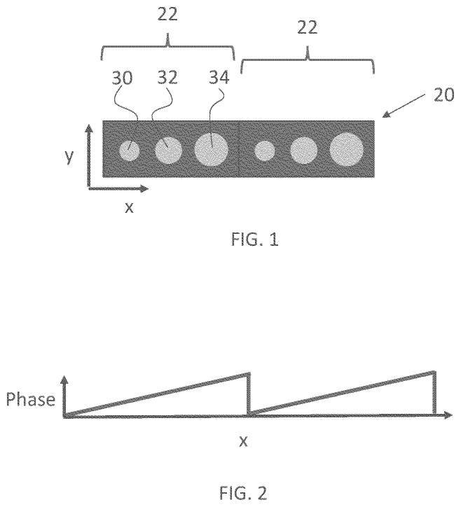

FIG. 1 illustrates an example of an optical grating 20 that includes multiple cells 22, each of which includes a sequence of meta-atoms 30, 32, 34 arranged along a first direction (e.g., the direction of the x-axis, which is the longer axis of the cell). In the example of FIG. 1, the meta-atoms are aligned with respect to a second direction (e.g., the direction of the y-axis), which is orthogonal to the first direction. That is, the centers of the respective meta-atoms 30, 32, 34 are substantially aligned along the same axis. The meta-atoms in each particular cell can have sizes (e.g., diameters) that differ from one another. In some implementations, at least one of shape, size or location of the meta-atoms differs among the cells 16. Thus, the meta-atoms need not necessarily be repeated in a periodic pattern from cell to cell. Instead, in some instances, one or more of the shape, size or location of the meta-atoms may vary slightly from one cell to the next. For example, in some implementations, one or more of the shape, size or location of the meta-atoms may vary slightly from one cell to the next to achieve desired optical deflection angles. In some implementations, a cell size differs among the cells.

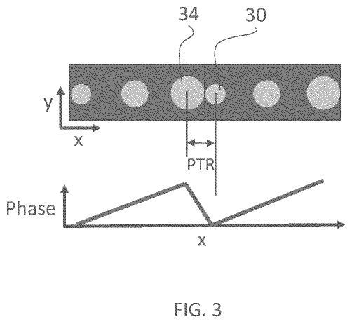

Using a configuration in which the meta-atoms are aligned as shown in FIG. 1 can make it difficult to obtain a smooth saw-tooth type phase distribution (see FIG. 2) because the minimum distance between the respective centers of the largest diameter meta-atom 34 and the smallest diameter meta-atom 30 is the sum of their radii (see FIG. 3). That distance corresponds to the phase transition region (PTR). As the size of this region becomes larger, the performance of the grating may become worse. Even for the smallest PTR (FIG. 2), the phase distribution will not be a smooth saw-tooth in a regular pillar-based MOE grating. Further, placing the pillars so close may lead to increased cross-talk and may decrease the overall transmission capability of the grating.

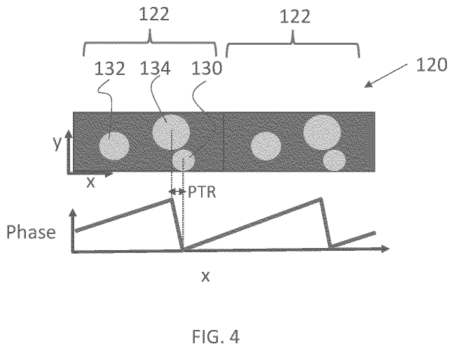

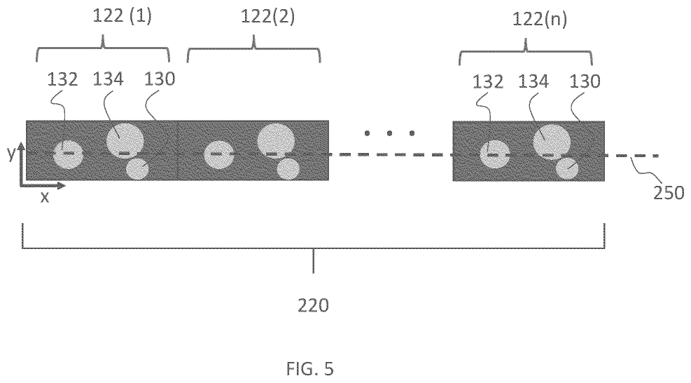

In accordance with some implementations of the present disclosure, as shown in the example of FIG. 4, an optical grating 120 includes multiple cells 122, each of which includes a sequence of meta-atoms 130, 132, 134 arranged along a first direction (e.g., the direction of the x-axis corresponding to the longer dimension of the grating). In general, the respective diameters of the smallest and largest meta-atoms should be selected to complete a 2π phase transition (i.e., wrap around). In contrast to the example of FIG. 1, the meta-atoms 130, 132, 134 are not aligned with respect to a second direction (e.g., the direction of the y-axis corresponding to the shorter dimension of the grating), which is different from the first direction. That is, the centers of at least some of the respective meta-atoms 130, 132, 134 are not aligned along the same axis as other ones of the meta-atoms in the same cell 122. Instead, the meta-atoms are disposed at different positions in the y-direction. Such arrangements can facilitate obtaining a design that has a significantly reduced PTR (see the lower part of FIG. 4) and, in some instances, a design whose phase distribution is closer to the ideal distribution of FIG. 2. Accordingly, grating performance can be improved in some cases. In some implementations, each of the cells 122 has a dimension shorter than an operational wavelength for the grating 120 (e.g., shorter than the wavelength of light emitted by a VCSEL or other light source with which the grating is being used).

In general, the first and second directions may be orthogonal or non-orthogonal with respect to one another, depending on the implementation. For example, for rectangular cells 122, the first and second directions may be orthogonal to one another. On the other hand, for hexagonal cells, the first and second directions may be non-orthogonal to one another.

As also shown in the example of FIG. 4, the meta-atoms can be arranged such that the non-alignment is asymmetrical. In some implementations, the center of the refractive index of the meta-atoms 130, 132, 134 in a cell 122 lies at, or close to, the center axis of the grating (e.g., a line parallel to the x-axis in FIG. 4).

Although FIG. 4 illustrates two cells 122 each of which has three meta-atoms 130, 132, 134, other implementations may include a different number of cells and/or meta-atoms per cell. For example, in some implementations, a cell 122 may have as many as fifteen, or more, meta-atoms. Using relatively small cells 122 can facilitate obtaining a grating that operates at a relatively large deflection angle. The cell 122 can be replicated along the first direction (e.g., the direction of the x-axis) just a few times or tens, hundreds or thousands of times, as shown in FIG. 5 for a grating 220 that includes cells 122(1), 122(2) . . . 122(n). For example, for a grating having a length of several microns, the cell 122 may be replicated on the order of about one thousand times, in some cases. Within each particular cell 122(1), 122(2) . . . 122(n), the meta-atoms are arranged in an asymmetric manner about the central axis 250 of the grating. In some instances, the cell 122 can be replicated with slight changes, such as the size of unit elements, the location of the meta-atoms, or the size (e.g., diameter) of the meta-atoms.

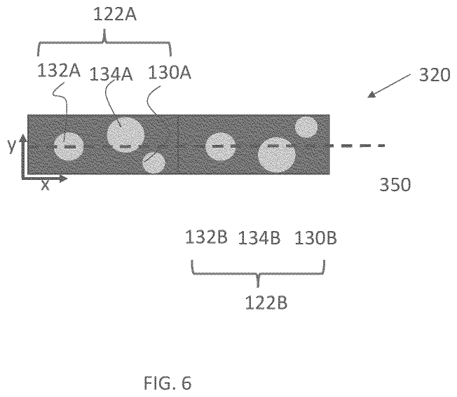

In some instances, one or more of the cells may be a mirror image of other ones of the cells. For example, the arrangement of meta-atoms of a cell may be rotated 180° about a central axis along the direction in which the cells are distributed. For example, as shown in FIG. 6, the meta-atoms 130B, 132B, 134B of a second cell 122B are rotated 180° about the central axis 350 relative to the meta-atoms 130A, 132A, 134A of a first cell 122A. Within each particular cell 122A, 122B, the meta-atoms are arranged in an asymmetric manner about the central axis 350. Simulations indicate that flipping the cell 122B along the shorter side of the grating 320 relative to the cell 122A does not change the grating's optical performance.

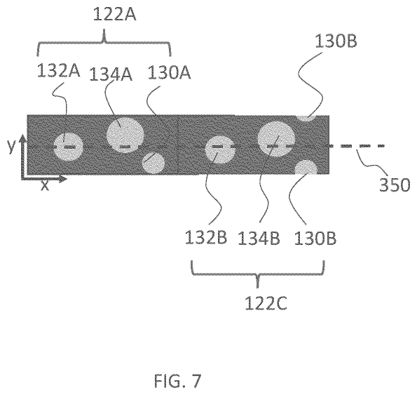

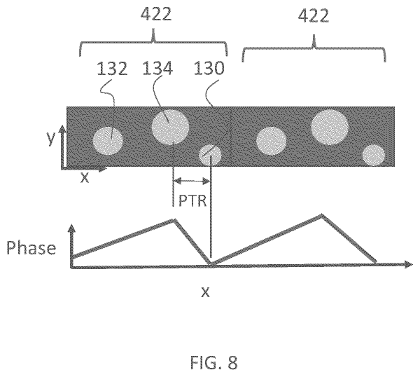

In some instances, one or more of the cells is shifted laterally along the second direction (e.g., in the direction of the y-axis) relative to other ones of the cells. FIG. 7 illustrates an example, in which the meta-atoms in cell 122C are shifted in the second direction (i.e., along the shorter dimension of the grating) relative to the meta-atoms in cell 122A. Simulations indicate that such lateral shifting of the cell 122C relative to the cell 122A does not change the grating's optical performance.

As noted above, in some implementations, using an arrangement in which the meta-atoms are not aligned and are disposed in an asymmetric manner (e.g., FIG. 4) can result in a smaller PTR than might be achieved using an arrangement in which the meta-atoms are aligned (FIGS. 1 and 2). Although the resulting PTR may be reduced in some cases, the PTR need not necessarily be minimized. Instead, the PTR can be optimized together with other variables to achieve a desired phase distribution and optical performance.

Further, in some implementations, although the grating has an arrangement in which the meta-atoms are not aligned and are disposed in an asymmetric manner, the PTR may be greater than what might be achieved using an arrangement in which the meta-atoms are aligned. Thus, in some instances, the respective positions of two adjacent meta-atoms may at least partially overlap in the first direction (i.e., in the direction of the longer length of the grating) (see FIGS. 4 and 5), whereas in other instances, the respective positions of the meta-atoms may not overlap at all in the first direction (see FIG. 8). In each of these situations, the non-alignment can provide an extra degree of freedom in the design of the grating.

The meta-atoms of the grating can be composed, for example, of a relatively high refractive index material (e.g., amorphous silicon) that changes one or more characteristics of incident light in a particular way. In some instances, the meta-atoms are pillar-shaped nanostructures on a glass or other substrate. As noted above, the meta-atoms may have other shapes in some implementations.

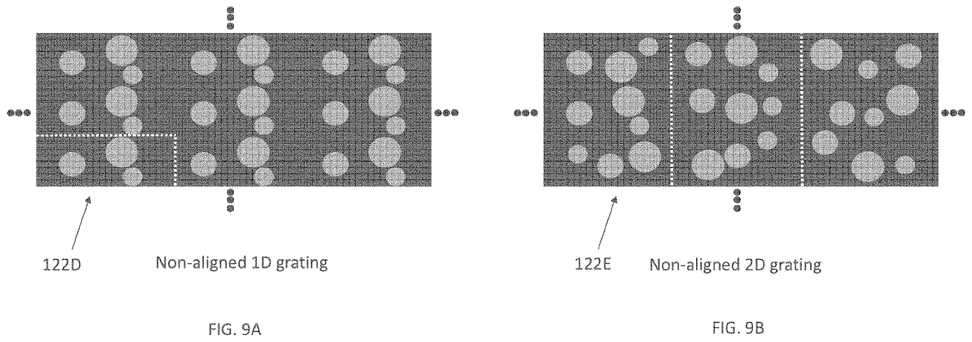

Although the foregoing examples describe arrangements of meta-atoms for one-dimensional (1D) (line) gratings, the techniques can be used for two-dimensional (2D) gratings as well. For example, FIG. 9A illustrates an example of a grating in which each cell 122D has three meta-atoms in a one-dimensional arrangement, whereas FIG. 9B illustrated an example of a rating in which each cell 122E has nine meta-atoms in a two-dimensional arrangement.

Any of the foregoing optical gratings of FIGS. 4 through 9B can be incorporated into a wide range of applications, including focusing or emitting lenses, optical collimators, and other applications that employ optical phase distribution. In general, the non-alignment techniques can be advantageous for arrangements in which the meta-atoms have a limited diameter range. The optical gratings also can be used in instruments such as spectrometers to separate polychromatic light into the underlying constituent wavelengths of which the light is comprised.

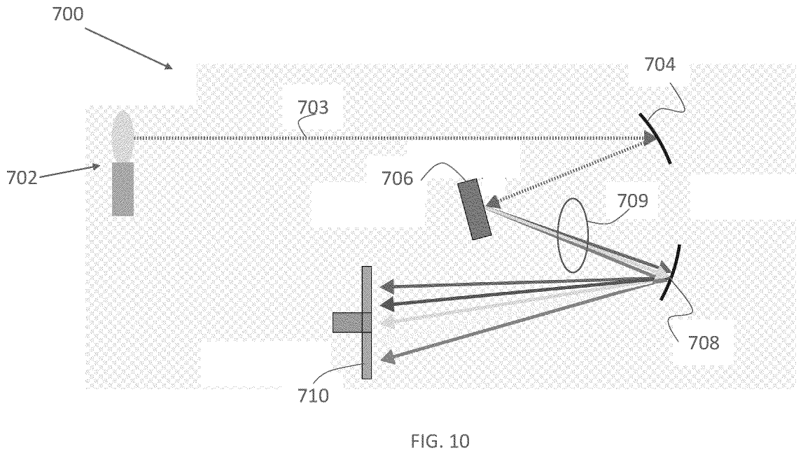

FIG. 10 illustrates an example of an optical system 700 (e.g., a spectrometer) in which a grating 706, as described above in any of FIGS. 4-8, can be incorporated. The system 700 includes a light source 702 that emits polychromatic (e.g., white) light 703, and an optical detector 710 that can detect a broad range of wavelengths of light 709. Mirrors or other reflective surfaces 704, 708 can be provided to direct the light 703, 709, respectively, to the grating 706 or toward the detector 710. In some instances, one or more transmissive surfaces may be provided to direct light to the grating 706 or toward the detector.

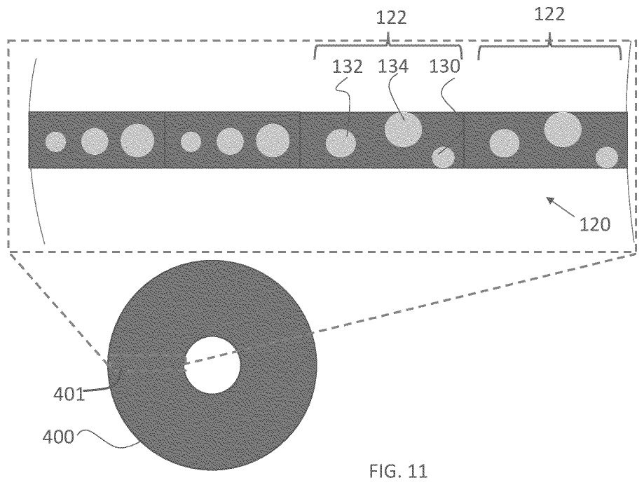

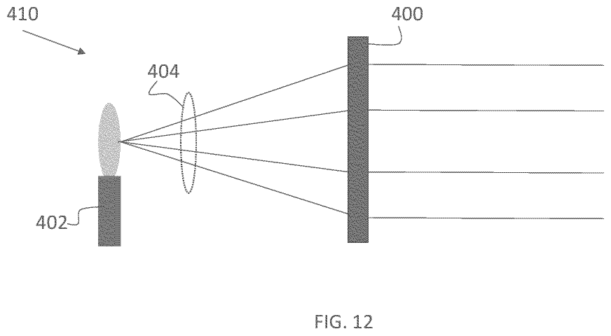

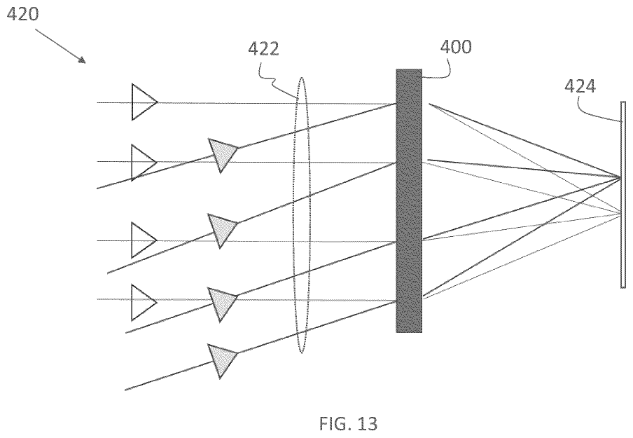

In some implementation, as shown in FIG. 11, any of the optical gratings described above (e.g., gratings 120, 220, 320) can serve as a portion 401 of a metalens 400. For example, as shown in FIG. 11, an optical grating 120 includes one or more cells 122 having non-aligned meta-atoms 130, 132, 134 and forms a portion 401 of an annular ring of the meta-lens 400. The structure of the optical grating 120 can be repeated to form the annular ring section of the metalens. Thus, in some cases, the metalens may be symmetric as one rotates about the center of the metalens, and may be asymmetric in the radial direction. As shown in FIG. 12, the metalens 400 can be integrated, for example, into an optical transmitter system 410 that includes a light source 402 operable to generate light beams 404 that passes through the metalens. In such implementations, the metalens 400 can provide, for example, a collimating function for the light beams 404. In other cases, as shown in FIG. 13, a metalens 400 can be integrated into an optical receiver system 420 (e.g., a camera) in which the metalens directs light beams 422, for example, to an image sensor 424 or other optical detector(s).

While this specification contains many specifics, these should not be construed as limitations on the scope of the disclosure or of what may be claimed, but rather as descriptions of features specific to particular implementations. Certain features described in this specification in the context of separate implementations also may be combined in the same implementation. Conversely, various features described in the context of a single implementation also may be implemented in multiple implementations separately or in any suitable sub-combination. Various modifications can be made to the foregoing examples. Accordingly, other implementations also are within the scope of the claims.

1. An apparatus comprising:
an optical grating having a first axis oriented in a first direction and a second axis oriented in a second direction different from the first direction, wherein a dimension of the optical grating along the first axis is greater than a dimension of the optical grating along the second axis, the optical grating including cells arranged along the first direction, each of the cells including meta-atoms arranged along the first direction, wherein the meta-atoms in each particular one of the cells are not aligned with respect to the second direction and are arranged in an asymmetric manner about the first axis of the optical grating.

2. The apparatus of claim 1 wherein each of the cells has a same arrangement of meta-atoms as other cells of the optical grating.

3. The apparatus of claim 1 wherein an arrangement of the meta-atoms in at least one of the cells is rotated 180°, with respect to an arrangement of the meta-atoms in another one of the cells, about a central axis of the grating.

4. The apparatus of claim 1 wherein an arrangement of the meta-atoms in at least one of the cells is shifted along the second direction relative to an arrangement of the meta-atoms in another one of the cells.

5. The apparatus of claim 1 wherein:
an arrangement of the meta-atoms in at least one of the cells is rotated 180°, with respect to an arrangement of the meta-atoms in another one of the cells, about the central axis of the grating; and
an arrangement of the meta-atoms in at least one of the cells is shifted along the second direction relative to an arrangement of the meta-atoms in the other one of the cells.

6. The apparatus of claim 1, wherein the meta-atoms in each particular one of the cells has a respective size, shape or orientation that differs, respectively, from the size, shape or orientation of other ones of the meta-atoms in the same cell.

7. The apparatus of claim 1, wherein respective positions of two meta-atoms in at least one of the cells overlap partially in the first direction.

8. The apparatus of claim 1, wherein the meta-atoms in each particular cell of the optical grating are in a two-dimensional arrangement.

9. The apparatus of claim 1, further including:
a light source operable to emit light;
an optical detector operable to detect light; and
at least one reflective or transmissive surface to direct light emitted by the light source to the optical grating or to direct light from the optical grating to the optical detector.

10. The apparatus of claim 1, wherein each of the cells has a dimension shorter than an operational wavelength for the optical grating.

11. The apparatus of claim 1, wherein at least one of shape, size or location of the meta-atoms differs among the cells.

12. The apparatus of claim 1, wherein a cell size differs among the cells.

13. The apparatus of claim 1, wherein the optical grating is part of a metalens.
